(19) United States
(12) Patent Application Publication
(10) Pub. No.: US 2026/0151834 A1
(43) Pub. Date: Jun. 4, 2026

(54) DEBURRING EXTERNAL CHAMFER TOOL WITH CUTTING INSERT MOUNTING STRUCTURE

(71) Applicant: Hong Ann Tool Industries Co., Ltd., Taichung City (TW)

(72) Inventor: Cheng-Wei SU, Taichung City (TW)

(21) Appl. No.: 18/966,332

(22) Filed: Dec. 3, 2024

(51) Int. Cl. B23B 5/16; B23G 9/00

(52) U.S. Cl. CPC B23B 5/167; B23G 9/003

(57) ABSTRACT

A deburring external chamfer tool includes a body rotatable about an axis, a cutting insert, and an elastically deformable fastening member. The body includes a connecting end and a working end with a conical cutting space. An insert pocket having a bottom surface forms on an inner wall surface adjacent to the cutting space. The cutting insert mounts within the insert pocket against the bottom surface. The fastening member detachably engages with the body while pressing against the cutting insert end opposite the bottom surface. The conical cutting space extends from the working end toward the connecting end with a gradually decreasing width.

### BACKGROUND OF THE INVENTION

The invention relates to a deburring external chamfer tool, and more particularly to a deburring external chamfer tool having a cutting insert mounting structure.

U.S. Pat. No. 9,821,393 discloses a rotary cutting tool for trimming workpieces. The tool comprises a body rotatable about a central axis. One end of the body, along the axial direction of the rotating axis, forms a connecting end, while the opposite end forms a working end. The body includes a cutting space that is recessed along the axial direction at the working end, extending from the working end toward the connecting end. A cutting edge is provided on the inner wall surface adjacent to the cutting space. The body further defines a reference plane in the radial direction of the rotating axis, perpendicular to the rotating axis and passing through the cutting edge. On this reference plane, the radial distance from the cutting edge to the rotating axis is less than the distance from any point on the inner wall surface adjacent to the cutting space to the rotating axis.

The tool features a unitary construction wherein the cutting edge is integrally formed with the tool body. This tool is commonly employed when screw thread ends are damaged. In typical practice, a thread chaser is initially used to re-cut the threads at the screw end. The reverse tooth rotary cutter is employed directly to remove the damaged section entirely only when the screw exhibits severe damage or exceptional hardness that renders thread chaser use ineffective. Consequently, the reverse tooth rotary cutter must be manufactured from high-hardness material. However, tools constructed from high-hardness metals result in elevated manufacturing costs.

The present invention is, therefore, intended to obviate or at least alleviate the problems encountered in the prior art.

### SUMMARY OF THE INVENTION

The invention is a deburring external chamfer tool having a cutting insert mounting structure. The deburring external chamfer tool comprises a body having a connecting end and a working end. The working end includes at least one cutting space configured to accommodate cutting operations. The body is rotatable about a rotation axis and has a connecting end and an opposite working end along the rotation axis. A cutting space is concavely formed in the working end along the rotation axis and extends toward the connecting end. The cutting space width gradually decreases along the radial direction to form a conical space. At least one insert pocket is formed on an inner wall surface adjacent to the cutting space. The insert pocket has a bottom surface at its end near the connecting end. At least one cutting insert is mounted in the insert pocket with one end abutting the bottom surface. A fastening member that is elastically deformable and detachably engages with the body while pressing against the end of the cutting insert opposite from the bottom surface.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the concept upon which this disclosure is based may readily be utilized as a basis for designing other structures, methods, and systems for carrying out the several purposes of the invention. It is important, therefore, that the claims be regarded as including such equivalent constructions insofar as they do not deviate from the spirit and scope of the invention.

Furthermore, the purpose of the abstract is to enable the general public, particularly scientists, engineers, and practitioners in the field who may not be familiar with patent or legal terminology, to quickly determine the nature and essence of the technical information through a brief examination. The abstract is not meant to define the invention, which is determined by the claims, nor is it intended to limit the scope of the invention in any manner.

Other objectives, advantages, and new features of the invention will become apparent from the following detailed description of the invention when considered in conjunction with the accompanied drawings.

### BRIEF DESCRIPTION OF DRAWINGS

FIG. 1 is a perspective view of a deburring external chamfer tool having a cutting insert mounting structure in accordance with a first embodiment of the invention.

FIG. 2 is an exploded perspective view of the deburring external chamfer tool of FIG. 1.

FIG. 3 is a sectional view showing a fastening member of the deburring external chamfer tool of FIG. 1.

FIG. 4 is a cross-sectional view taken along line 4-4 in FIG. 3.

FIG. 5 is a cross-sectional view showing the reference plane in FIG. 1.

FIG. 6 is a perspective view of a deburring external chamfer tool having a cutting insert mounting structure in accordance with a second embodiment of the invention.

FIG. 7 is an exploded perspective view of FIG. 6.

FIG. 8 is a sectional view showing a fastening member of the deburring external chamfer tool of FIG. 6.

FIG. 9 is a cross-sectional view taken along line 9-9 in FIG. 8.

### DETAILED DESCRIPTION OF THE INVENTION

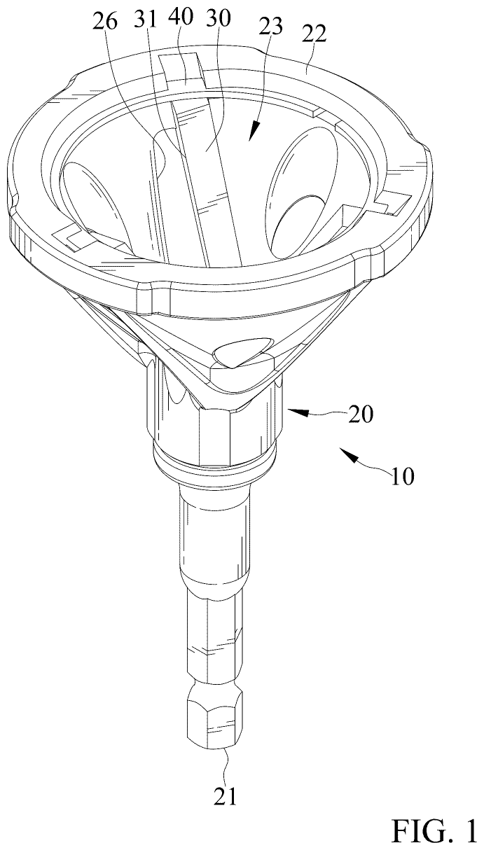

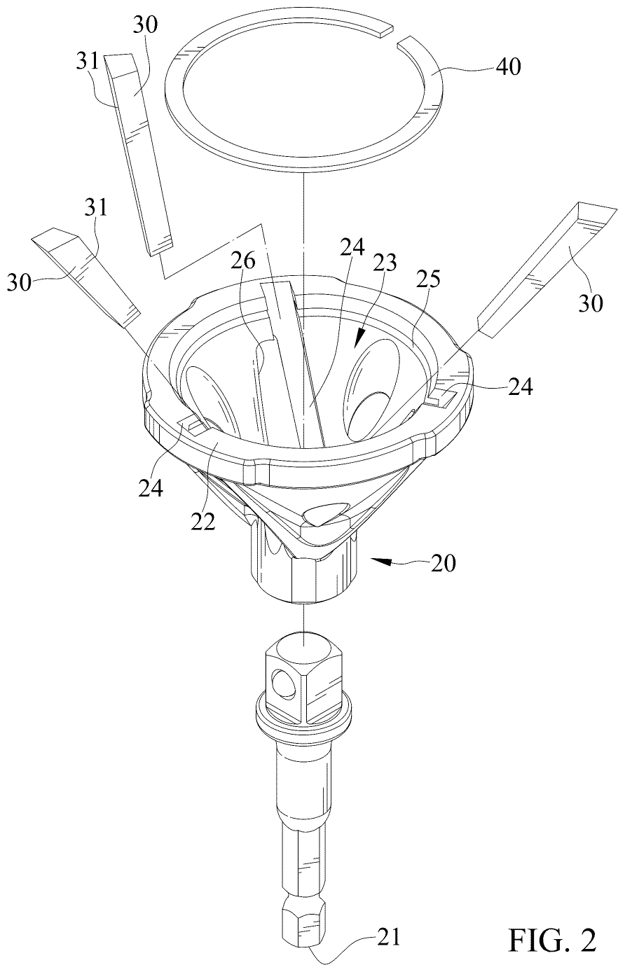

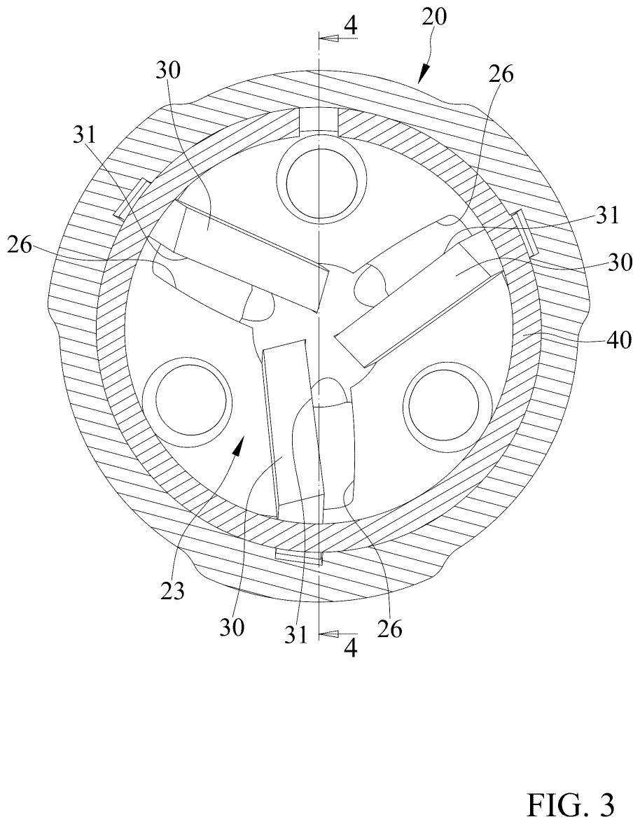

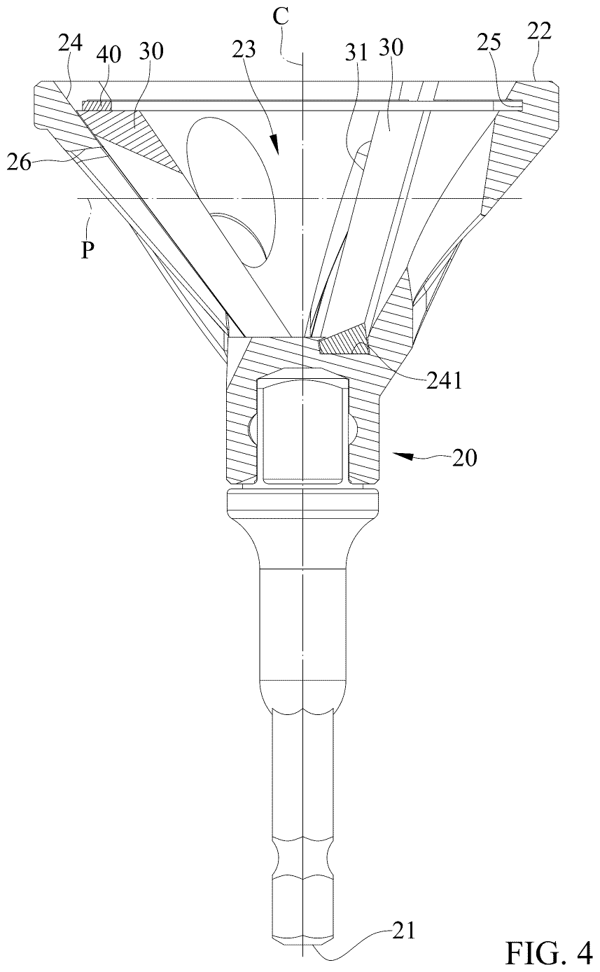

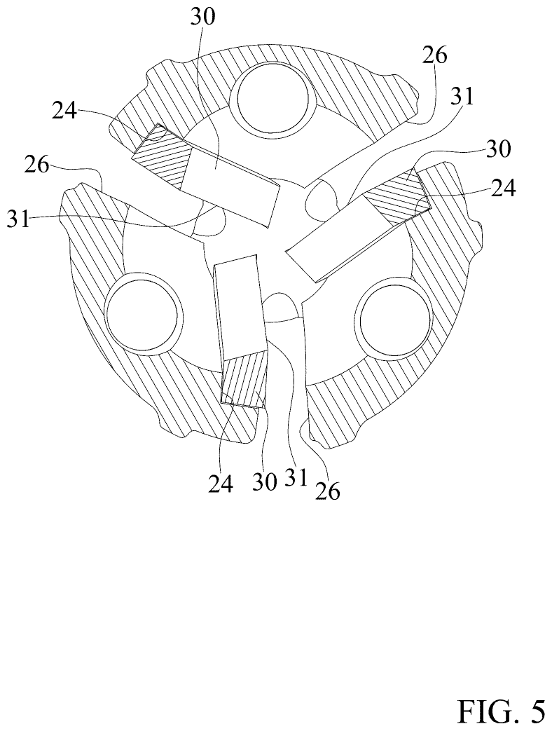

Referring to FIGS. 1-5, a deburring external chamfer tool 10 having a cutting insert mounting structure according to a first embodiment of the present invention comprises a body 20, at least one cutting insert 30, and a fastening member 40.

The body 20 is rotatable about a rotation axis C and includes a connecting end 21 and an opposite working end 22 along the rotation axis C. The connecting end 21 is configured to couple with a power tool or pneumatic tool. A cutting space 23 is concavely formed in the working end 22 along the rotation axis C. The cutting space 23 extends from the working end 22 toward the connecting end 21, with its width gradually decreasing along the radial direction of the rotation axis C to form a conical space. The cutting space 23 is formed with a predetermined conical angle, preferably in the range between 30° to 60°, configured for use with common thread sizes. The conical profile ensures proper chip formation and prevents binding during operation.

At least one insert pocket 24 is formed on an inner wall surface adjacent to the cutting space 23. The insert pocket 24 includes a bottom surface 241 disposed at an end thereof proximate to the connecting end 21. The insert pocket 24 comprises supporting walls machined at predetermined angles configured to withstand cutting forces and depth stops to prevent insert movement under cutting forces.

The at least one cutting insert 30 is mounted in the insert pocket 24 with a first end thereof abutting the bottom surface 241. The cutting insert 30 is further secured via adhesive bonding to an inner peripheral surface of the insert pocket 24.

The adhesive bonding between the cutting insert 30 and insert pocket 24 is achieved using adhesives suitable for metallic bonding.

The fastening member 40 is elastically deformable and detachably engages with the body 20 while pressing against the end of the cutting insert 30 opposite from the bottom surface 241. Specifically, the fastening member 40 presses against an end face of the cutting insert 30 that is disposed closest to the working end 22 along the rotation axis C.

In operation, the deburring external chamfer tool 10 connects the connection end 21 to a driving tool, and the cutting space 23 encloses an end of the bolt. When the driving tool rotates the deburring external chamfer tool 10, the cutting insert 30 removes a predetermined number of threads from the bolt end, facilitating subsequent nut engagement with the bolt.

The cutting insert 30 is combined with the body 20 via the fastening member 40, it allows the cutting insert 30 to be made from a different material than the body 20. The cutting insert 30 is preferably fabricated from a material having a hardness greater than that of the body 20, such as tungsten carbide. This configuration enables the deburring external chamfer tool 10 to effectively cut high-hardness screws while maintaining cost effectiveness, as only the cutting insert 30 requires fabrication from high-hardness material.

The fastening member 40 exhibits elastic deformation properties through its material composition and structural design. Suitable materials include, but are not limited to, spring steel

The structure of the deburring external chamfer tool 10 ensures that during rotation, only a cutting edge 31 of the cutting insert 30 contacts the bolt, thereby ensuring smooth cutting operation without generating excessive resistance. Additionally, chips generated during cutting operations are evacuated through at least one chip removal groove 26. The at least one chip removal groove 26 is disposed radially along the inner wall adjacent to the cutting space 23. A first end of the at least one chip removal groove 26 communicates with the cutting space 23, and a second end thereof extends through to an outer periphery of the body 20, thereby facilitating chip evacuation during cutting operations. In the present embodiment, a plurality of chip removal grooves 26 are provided. Preferably, the chip removal grooves 26 are disposed at varied angles along the inner wall adjacent to the cutting space 23 to enhance chip evacuation during cutting operations.

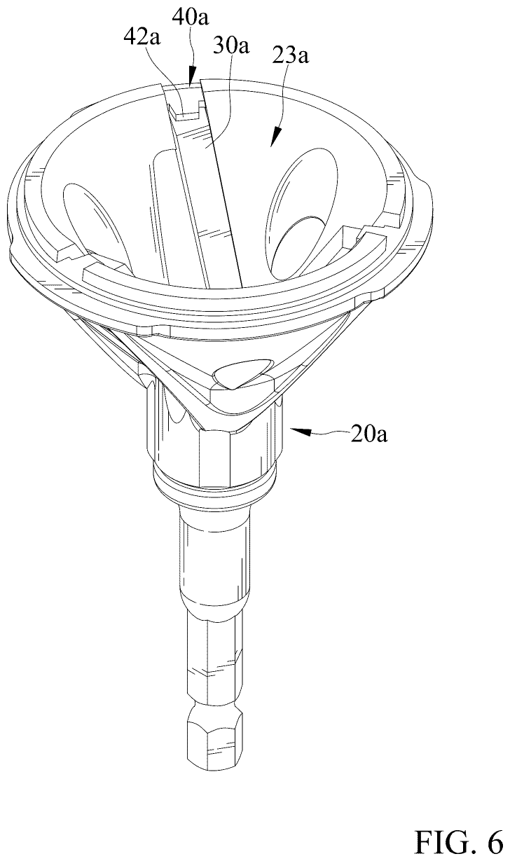

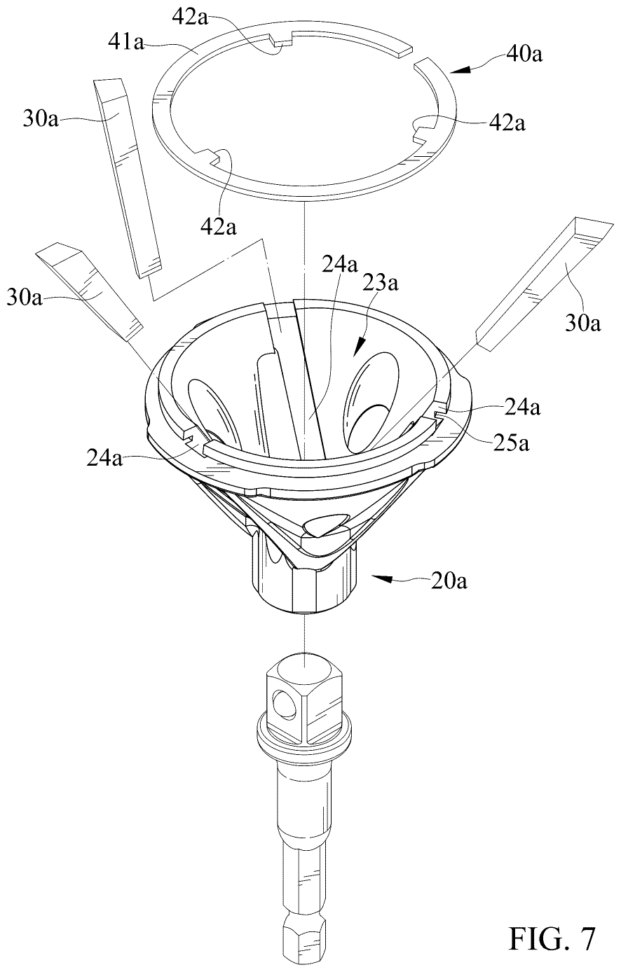

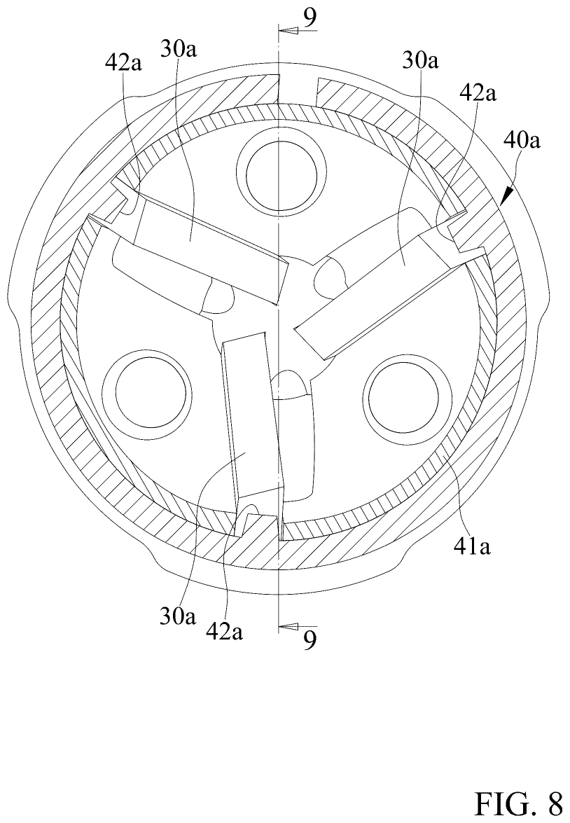

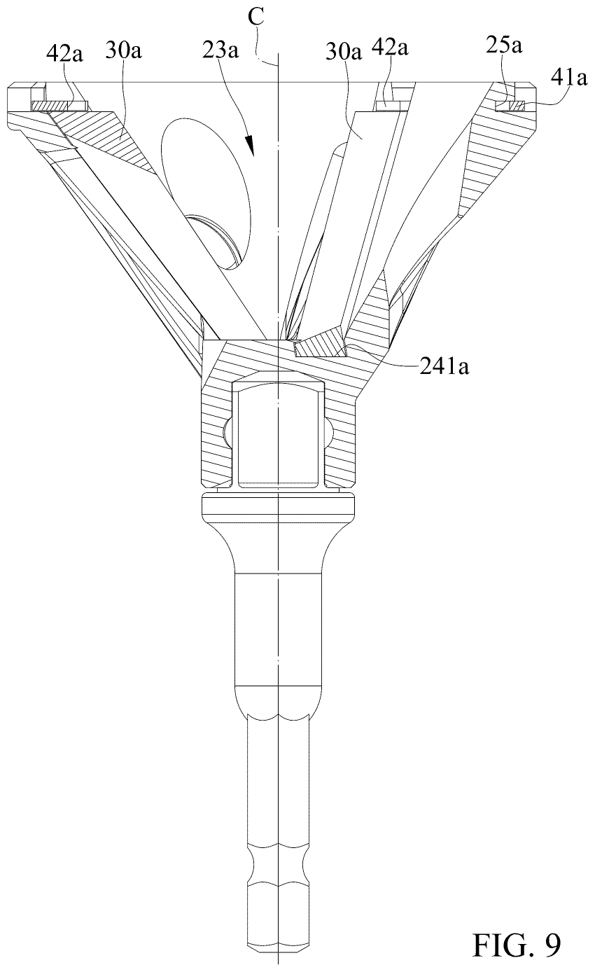

Referring to FIGS. 6 through 9, a deburring external chamfer tool according to a second embodiment shares many characteristics with the first embodiment but introduces structural modifications to enhance cutting insert retention and assembly flexibility. Components similar to those of the first embodiment have like reference numerals with the suffix “a”.

The second embodiment comprises a main body 20a including an annular recessed portion 25a disposed along an external circumference thereof, centered about rotation axis C. The annular recess portion 25a communicates with insert pockets 24a to enable a secure locking mechanism using an alternative fastening member 40a. The fastening member 40a comprises an annular outer ring 41a and a plurality of inner protrusions 42a configured to align with and insert into respective insert pockets 24a. Each inner protrusion 42a is configured to firmly support against an end of a respective cutting insert 30a opposite a bottom surface 241a, thereby providing enhanced stability while facilitating assembly and disassembly operations. This configuration ensures that each cutting insert 30a remains securely seated during rotation, providing resilient coupling even in high-speed or high-torque applications. Furthermore, the symmetrical distribution of the fastening member's inner protrusions 42a enables a balanced load on the cutting inserts 30a, thereby minimizing vibration and improving the tool's operational lifespan.

In the present embodiment, three insert pockets 24a, three cutting inserts 30a, and three inward protrusions 42a are provided. The three cutting inserts 30a are disposed in the three insert pockets 24a and are uniformly distributed along the inner wall of cutting space 23a about the rotation axis C.

In view of the foregoing, the deburring external chamfer tools 10 have a structure that enhance the hardness of the cutting inserts 30 and 30a and securely bonds them to the bodies 20 and 20a. This allows the use of different materials for the cutting inserts 30 and 30a and the tool bodies 20 and 20a, with high-hardness materials (e.g., tungsten carbide) being used only for the cutting inserts 30 and 30a. This reduces overall tool cost compared to unitary high-hardness construction. The deburring external chamfer tools 10 provides secure mounting of the cutting inserts 30 and 30a through multi-point contacts, ensures smooth cutting action with minimal resistance, facilitates chip evacuation through dedicated chip removal grooves 26, enables quick replacement of worn cutting inserts, maintains consistent cutting geometry throughout tool life, reduces tool inventory requirements through modular design, and improves cost efficiency in high-volume production environments. The invention enables use of different materials for the cutting inserts 30 and 30a and body 20 and 20a, allows replacement of worn cutting inserts, improves chip evacuation efficiency, and provides secure mounting through the fastening member system.

Although specific embodiments have been illustrated and described, numerous modifications and variations are still possible without departing from the scope of the invention. The scope of the invention is limited by the accompanying claims.

1. A deburring external chamfer tool with a cutting insert mounting structure, comprising:
a body rotatable about a rotation axis, wherein the body has a connecting end and a working end opposite the connecting end along the rotation axis, wherein the body comprises a cutting space concavely formed in the working end along the rotation axis, wherein the cutting space extends from the working end toward the connecting end and has a width that gradually decreases along a radial direction of the rotation axis to define a conical space, wherein the body comprises at least one insert pocket formed on an inner wall surface adjacent to the cutting space, and wherein the at least one insert pocket includes a bottom surface at an end thereof proximate to the connecting end;
at least one cutting insert mounted in the at least one insert pocket, wherein a first end of the at least one cutting insert abuts the bottom surface; and
a fastening member elastically deformable and detachably engaged with the body, wherein the fastening member presses against a second end of the at least one cutting insert opposite from the bottom surface.

2. The deburring external chamfer tool as claimed in claim 1, wherein the at least one cutting insert is adhesively bonded to an inner peripheral surface of the at least one insert pocket.

3. The deburring external chamfer tool as claimed in claim 1, wherein the fastening member presses against an end face of the at least one cutting insert that is disposed closest to the working end along the rotation axis.

4. The deburring external chamfer tool as claimed in claim 1, wherein the at least one insert pocket has an end opposite from the connecting end and connected to the working end, and wherein the end does not connect to an outer periphery of the body along the radial direction of the rotation axis.

5. The deburring external chamfer tool as claimed in claim 1, wherein the body includes an annular recessed portion centered on the rotation axis formed on the inner wall surface adjacent to the cutting space, wherein the inner annular recessed portion intersects and communicates with the at least one insert pocket, and wherein the fastening member is detachably engaged with the annular recessed portion.

6. The deburring external chamfer tool as claimed in claim 1, wherein the body includes an annular recessed portion disposed along a radial outer periphery thereof, and the fastening member is detachably engaged within the outer annular recessed portion.

7. The deburring external chamfer tool as claimed in claim 6, wherein the fastening member comprises an annular outer ring and at least one inner protrusion extending from an inner circumference of the outer ring, wherein the outer ring is configured to fit into the annular recessed portion, and wherein each of the at least one inner protrusion engages a corresponding insert pocket to brace the at least one cutting insert.

8. The deburring external chamfer tool as claimed in claim 1, wherein each of the at least one cutting insert includes a cutting edge positioned along a reference plane perpendicular to the rotation axis, wherein a first radial distance from the cutting edge to the rotation axis is less than a second radial distance from any point on an inner wall surface of the cutting space to the rotation axis, and wherein the inner wall surface is adjacent to the respective cutting insert.

9. The deburring external chamfer tool as claimed in claim 1, comprising: at least one chip removal groove positioned radially along the inner wall adjacent to the cutting space, wherein a first end of the at least one chip removal groove communicates with the cutting space, and a second end of the at least one chip removal groove extends through to an outer periphery of the body, thereby facilitating chip removal during cutting operations.

10. The deburring external chamfer tool as claimed in claim 1, wherein: the cutting space is formed with a conical angle between 30 degrees and 60 degrees relative to the rotation axis.

11. The deburring external chamfer tool as claimed in claim 10, wherein the at least one cutting insert comprises a first material having a hardness greater than a hardness of a second material of the body.

12. The deburring external chamfer tool as claimed in claim 11, wherein the first material comprises tungsten carbide.

13. The deburring external chamfer tool of claim 9, wherein the at least one chip removal grooves comprises a plurality of chip removal grooves positioned at varied angles along the inner wall adjacent to the cutting space to facilitate enhanced chip evacuation during cutting operations.

14. The deburring external chamfer tool of claim 7, wherein the at least one insert pocket comprises three insert pockets; the at least one cutting insert comprises three cutting inserts; and the at least one inner protrusion comprises three inner protrusions, and wherein the three cutting inserts are uniformly distributed along the inner wall of the cutting space about the rotation axis.

15. The deburring external chamfer tool as claimed in claim 3, wherein the at least one cutting insert comprises a first material having a hardness greater than a hardness of a second material of the body.

16. The deburring external chamfer tool as claimed in claim 15, wherein the first material comprises tungsten carbide.

17. The deburring external chamfer tool of claim 7, wherein the at least one insert pocket comprises three insert pockets; the at least one cutting insert comprises three cutting inserts; and the at least one inner protrusion comprises three inner protrusions, and wherein the three cutting inserts are uniformly distributed along the inner wall of the cutting space about the rotation axis.
